(19) United States
(12) Patent Application Publication
(10) Pub. No.: US 2013/0247995 A1
(43) Pub. Date: Sep. 26, 2013

(54) Systems and Methods for a Control Valve

(71) Applicant: Daniel A. Ehrlich, Long Beach, CA (US)

(72) Inventor: Daniel A. Ehrlich, Long Beach, CA (US)

(73) Assignee: THE AEROSPACE CORPORATION, El Segundo, CA (US)

(21) Appl. No.: 13/425,149

(22) Filed: Mar. 20, 2012

(51) Int. Cl. F16K 47/14; G05D 7/03

(52) U.S. Cl. 137/1; 251/118; 137/565.17

(57) ABSTRACT

Embodiments of the invention relate to systems, methods, and apparatuses for a control valve. In one embodiment, a valve can be provided. The valve can include a flow restrictor portion operable to generate a pressure drop in a fluid flow by viscous dissipation; a throttle portion operable to change a flow rate of the fluid; and a guard portion operable to separate the flow restrictor portion from the throttle portion.

### TECHNICAL FIELD

The invention relates generally to controlling flow, and more particularly to systems and methods for a flow control valve.

### BACKGROUND OF THE INVENTION

Conventional flow control valves regulate flow using a variable area orifice that imposes a restriction on the fluid flow. An example conventional flow control valve is shown in FIG. 1. The pressure drop generated by this restriction is developed by accelerating the flowing fluid to high local velocities and then dissipating the resulting kinetic energy by means of turbulent dissipation. This physical mechanism, while effective in many applications, can result in significant durability and operability problems such as noise generation, vibration, and cavitation erosion in severe service applications where the requirement is to generate very large pressure drops or to discharge to pressures very close to the vapor pressure of the flowing fluid. An example graph illustrating the generated pressure drop along the flow path through the valve is also provided in FIG. 1. As shown, P1 is the pressure upstream of the valve, P2 is the pressure downstream of the valve, Pmin is the minimum pressure experienced by the flowing fluid within the valve, and Pv is the fluid vapor pressure. The figure illustrates that the acceleration of the fluid at high velocities through the narrow space between the plug and seat of the valve results in the fluid pressure at this location dropping below the discharged pressure (P2), potentially resulting in cavitation. A class of control valves known as “severe service” valves attempts to address the problems resulting from the presence of locally high fluid velocities with valve designs that employ multiple orifices and passages in series and/or parallel with the goal of producing a desired pressure while simultaneously reducing the magnitude of the peak flow velocities within the valve. Examples of such valves can be found in U.S. Pat. Nos. RE32,197; 7,013,919; and 5,390,896. To avoid cavitation, some valves may also provide limited pressure drop, thereby limiting their utility.

### SUMMARY OF THE INVENTION

Certain embodiments of the invention can provide systems and methods for a control valve. In one embodiment, a valve can be provided. The valve can include a flow restrictor portion operable to generate a pressure drop in a fluid flow by viscous dissipation; a throttle portion operable to change a flow rate of the fluid; and a guard portion operable to separate the flow restrictor portion from the throttle portion.

In one aspect of an embodiment, the valve can include a seal portion operable to decrease leakage between the throttle portion and the guard portion.

In one aspect of an embodiment, the flow restrictor portion can include a porous sleeve, the guard portion can include a perforated tube within the porous sleeve, and the throttle portion can include a piston within the perforated tube.

In one aspect of an embodiment, the flow restrictor portion can include at least one of: a porous media or a layered or stacked wire mesh or screen. Regardless of the construction, the flow restrictor portion may comprise a matrix of an indeterminately large number of randomly oriented passages in any series and/or parallel combination, which promote laminar flow and pressure drop through viscous dissipation.

In one aspect of an embodiment, the porous media of the flow restrictor portion may comprise a metal, plastic or ceramic, including one or more of stainless steel, brass, bronze, a porous metal, a porous plastic, or a porous ceramic.

In one aspect of an embodiment, the throttle portion can include at least one of the following: a translating piston, a sliding plate, a rotating cylinder, a rotating plate, a pivoting wall, or any suitable mechanism that can change the surface area of the restrictor portion exposed to the flow.

In one aspect of an embodiment, fluid flow can be reversed to flow in either direction through the valve.

In another embodiment, a method for controlling fluid flow can be provided. The method can include generating a pressure drop in the fluid flow by viscous dissipation within a valve comprising a throttle portion and a flow restrictor portion separated by a guard; and increasing or decreasing the flow rate of the fluid through a restrictor portion by adjusting the throttle portion.

In one aspect of an embodiment, a method can include reversing the fluid flow between the inlet and the outlet, wherein the fluid flows from the outlet to the inlet.

In one aspect of an embodiment, generating a pressure drop in the fluid flow by viscous dissipation can further include passing the fluid through a porous sleeve, wherein the fluid may also pass through one or more perforated tubes over which little to no pressure drop is generated.

In one aspect of an embodiment, controlling the flow rate of the fluid can include manipulating a throttle portion to vary the surface area of the restrictor exposed to the fluid flow. The throttle portion may be a piston or any other suitable device that can change the surface area of the flow restrictor exposed to the fluid flow.

In one aspect of an embodiment, the porous media may comprise a metal, plastic, or ceramic, including one or more of stainless steel, brass, bronze, a porous metal, a porous plastic, or a porous ceramic.

In one aspect of an embodiment, controlling the flow rate of the fluid can include manipulating at least one of the following: a translating piston, a sliding plate, a rotating cylinder, a rotating plate, a pivoting wall, or a mechanism which changes the flow area.

In another embodiment, a system for controlling fluid flow can be provided. The system can include at least one of the following: a storage tank, a pipe, a hose, a pump, or a valve. The valve can include a flow restrictor portion operable to generate a pressure drop in the fluid flow by viscous dissipation; a throttle portion operable to change a flow rate of the fluid through the restrictor portion; and a guard portion operable to separate the flow restrictor portion from the throttle portion.

In one aspect of an embodiment, the guard portion can include a perforated tube, the restrictor portion can include a porous sleeve adjacent to the perforated tube, and a throttle portion can include a piston within the perforated tube.

In one aspect of an embodiment, the restrictor portion can include at least one of a porous media, a layered, a stacked wire mesh, or a screen. Regardless of the construction, the flow restriction may comprise a matrix of an indeterminately large number of randomly oriented passages in series and/or parallel, which may promote laminar flow and pressure drop through viscous dissipation.

In one aspect of an embodiment, the porous media may comprise a metal, plastic, or ceramic, including one or more of stainless steel, brass, bronze, a porous metal, a porous plastic, or a porous ceramic.

In one aspect of an embodiment, the actuator portion can include at least one of the following: a translating piston, a sliding plate, a rotating cylinder, a rotating plate, a pivoting wall, or any suitable mechanism that can change the surface area of the restrictor exposed to the flow.

Other systems, methods, apparatuses, features, and aspects according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates one embodiment of a conventional valve and an associated pressure drop profile and velocity drop profile.

FIG. 2 illustrates a schematic block diagram of an example system and valve in accordance with an embodiment of the invention.

FIG. 3 illustrates a schematic view of an example valve in accordance with an embodiment of the invention.

FIG. 4 illustrates a schematic view of an example valve and pressure drop profile in accordance with an embodiment of the invention.

FIGS. 5A-5D illustrate schematic views of another example valve in accordance with an embodiment of the invention.

FIG. 6 illustrates a flow diagram of an example method for operating a valve in accordance with an embodiment of the invention.

### DETAILED DESCRIPTION OF EMBODIMENTS OF THE INVENTION

Embodiments of the invention will now be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “viscous dissipation” can refer to the dissipation of energy within a boundary layer between a body and a fluid, or in a fluid medium.

Certain embodiments of the invention generally provide for systems, methods, and apparatuses for a flow control valve. The valve design described herein with respect to embodiments of the invention can minimize or otherwise eliminate relatively high fluid velocities and associated problems found in conventional and existing severe service valve designs. A valve according to an embodiment of the invention can employ a porous media restrictor to generate a flow-controlling pressure drop by means of viscous dissipation rather than the high fluid velocity turbulent dissipation mechanism employed in conventional valve designs. By placing a porous media restrictor in series with a minimally restrictive orifice or orifices (also referred to herein as a guard or guard portion) in the valve flow passage, the presence of high velocity and turbulent flow about the orifice can be minimized or otherwise eliminated, and the pressure drop is instead controlled by viscous dissipation in the micro-passages within the porous media and not the guard. That is, the random and arbitrary passages in the porous media provide long (relative to diameter) convoluted passages that operate to generate pressure drop while limiting fluid flow velocity within the restrictor. This results in primarily laminar flow, which generates pressure drop by viscous dissipation.

Protecting the porous media restrictor may be the guard, which may be interposed between the porous media restrictor and an adjustable throttle, and may include a seal to minimize, if not prevent, leakage between the throttle and the restrictor. In this manner, the turbulent dissipation of relatively high fluid velocity in the prior art valves can be minimized or otherwise eliminated. A function of the guard is to separate the surface of the restrictor from the moving throttle thereby protecting it from damage induced by sliding contact between the restrictor and the throttle.

Use of a porous media restrictor can also minimize or otherwise eliminate the complex fabrication methods required to produce conventional multi-orificed severe service valves. Flow control can be accomplished by mechanically varying the size and/or number of orifices in the porous media of the restrictor element. One feature of certain system and valve embodiments is the placement of a guard element having minimally restrictive orifices in series with the porous media. In certain embodiments, the orifices of the guard may be sized sufficiently large with respect to the orifices of the porous media restrictor so that the guard has little to no effect on the fluid flow through the valve. To control flow through the valve, the orifices of the porous media restrictor may be blocked or partially blocked with a moving mechanical element, such as a throttle. The guard element can be disposed at least partially between the blocking element that is the throttle and the porous media restrictor to minimize or otherwise eliminate the potential for contact between the throttle and the porous media of the restrictor that could damage the porous media surface and damage the valve or otherwise render the valve inoperable.

The system and valve design described herein with respect to embodiments of the invention can improve the series and parallel orifice concepts seen in conventional severe service valve designs by employing a novel porous media restrictor which can include a very large number of random and arbitrary orifices. Use of a porous media restrictor can minimize or otherwise eliminate the relatively complex fabrication methods sometimes required to produce conventional multi-orifice severe service valves while simultaneously improving the multi-orifice concept from a finite number of orifices to an essentially infinite number. In this manner, the locally high velocities responsible for certain problems encountered in conventional severe service valves can be reduced or otherwise eliminated.

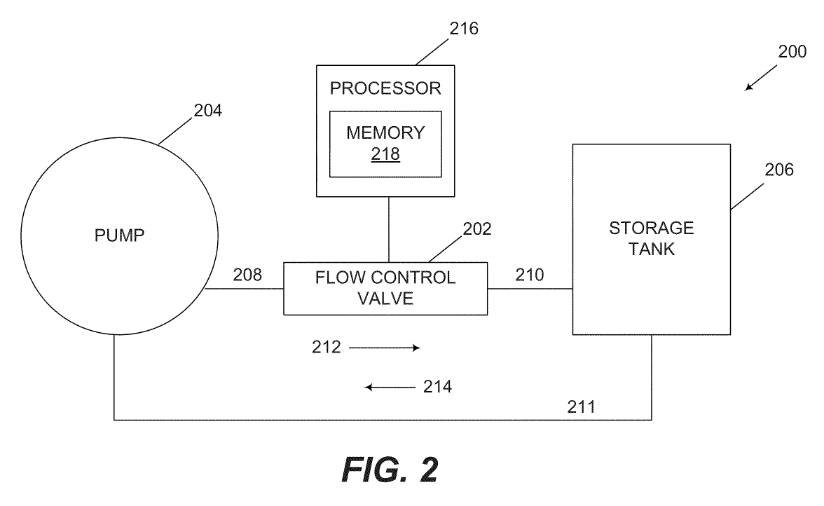

FIG. 2 illustrates an example system and valve in accordance with an embodiment of the invention. In the example shown, the system 200 can include a valve 202 in communication with a pump 204 and a storage tank 206. The valve 202 can be connected to the pump 204 via an inlet pipe 208, and can be further connected to the storage tank 206 via an outlet pipe 210. In a closed loop system, a return line 211 also connects the pump 204 and the storage tank 206. Generally, fluid flow through the valve 202 can be facilitated by the valve 202 in a first direction 212 from the pump 204 towards the storage tank 206. The return line 211 returns the fluid to the pump 204. In certain instances, fluid flow through the valve 202 can be in a second direction 214 from the storage tank 206 towards the pump 204, returning via return line 211. The instances of reverse fluid flow through the valve 202 may be useful for cleaning the valve 202 or otherwise clearing any prior fluid or debris in the valve 202. In any instance, flow control between the pump 204 and the storage tank 206 can be controlled by the valve 202. Alternatively, by way of example, the valve 202 can be located on return line 211, thereby illustrating that the valve can be disposed at either the inlet or discharge of pump 204, and may be desired.

In this embodiment, the system 200 can also include a microprocessor 216 and a memory 218 for storing one or more computer-executable instructions for controlling the system 200 and/or valve 202.

Other system embodiments in accordance with the invention can include fewer or greater numbers of components and may incorporate some or all of the functionalities described with respect to the system and valve components shown in FIG. 2.

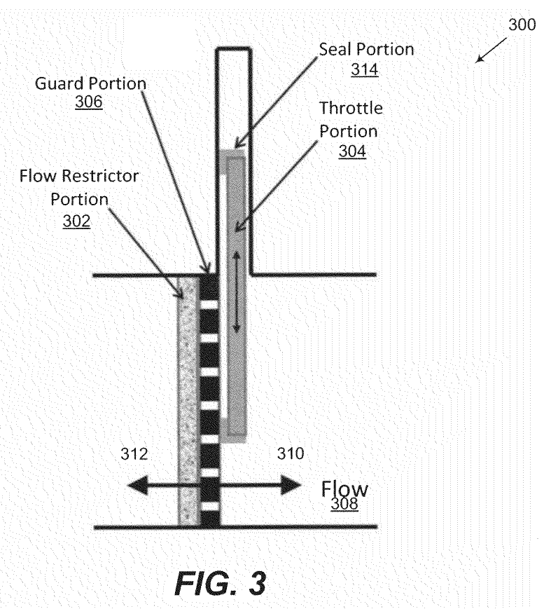

FIG. 3 illustrates a schematic view of an example valve in accordance with an embodiment of the invention. In this embodiment, a valve 300 can include a flow restrictor portion 302, a throttle portion 304, and a guard portion 306. The flow restrictor portion 302 can be operable to generate a pressure drop in a fluid flow, such as 308, by viscous dissipation, or at least predominantly viscous dissipation. Further, the throttle portion 304 can be operable to change a flow rate of the fluid flow 308. In addition, the guard portion 306 can be operable to separate the flow restrictor portion 302 from the throttle portion 304. Relative to the flow restrictor portion 302, the guard portion 306 produces negligible pressure drop, but provides tight clearances between the flow restrictor portion 302 and the throttle portion 304, thereby controlling leakage through the valve while simultaneously protecting the flow restrictor portion 302 from contact by the throttle portion 304. Generally, the valve 300 can control the fluid flow 308 in either direction 310, 312, as may be imposed by other components in the system that define a pressure gradient across the valve. Similar to certain instances described above in FIG. 2, the fluid flow through the valve 300 may be reversed for cleaning the valve 300 or otherwise clearing any prior fluid or debris in the valve 300.

In one embodiment, a valve such as 300 can include a seal portion 314 operable to decrease leakage between the throttle portion 304 and the guard portion 306. The seal portion 314 can be a gasket or other device which permits the throttle portion 304 to move with respect to the guard portion 306, and minimizes any leakage between the throttle portion 304 and the guard portion 306. Depending on the valve design, the seal portion 314 can be a stepped seal, a sliding contact seal, a piston ring seal, a face seal or any other suitable design to minimize leakage through the clearance between the throttle portion 304 and the flow restrictor portion 302.

As previously discussed, the guard portion 306 may protect the flow restrictor portion 302 from the throttle portion 304 and/or the seal portion 314. For example, if the flow restrictor portion 302 includes a sintered porous material, then contact with the throttle portion 304 and/or the seal portion 314 may damage the flow restrictor portion 302 by sealing pore entrances, and thus, interfering with valve function.

In one embodiment, a flow restrictor portion such as 302 can include at least one of a porous media or a layered or stacked wire mesh or screen. Materials suitable for the flow restrictor portion 302 include metal, plastic, or ceramic, such as stainless steel, brass, bronze, a porous metal, a porous plastic, or a porous ceramic.

In one embodiment, a throttle portion such as 304 can include at least one of the following: a translating piston, a sliding plate, a rotating cylinder, a rotating plate, a pivoting wall, or a mechanism which changes the flow area.

Other system embodiments in accordance with the invention can include fewer or greater numbers of components and may incorporate some or all of the functionalities described with respect to the system and valve components shown in FIG. 3.

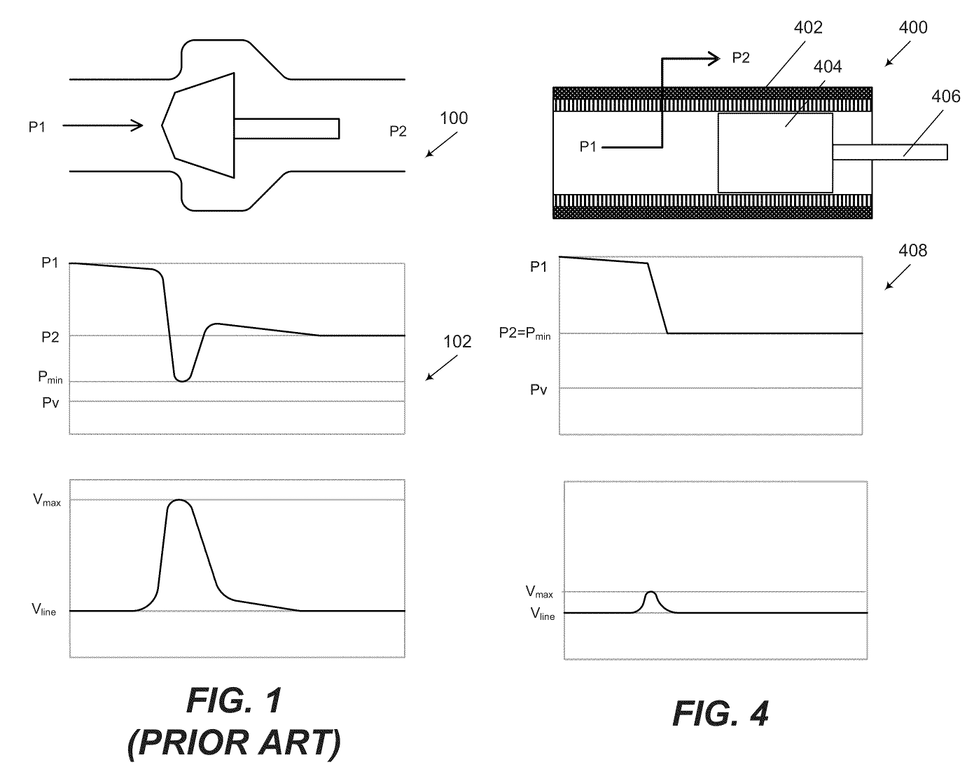

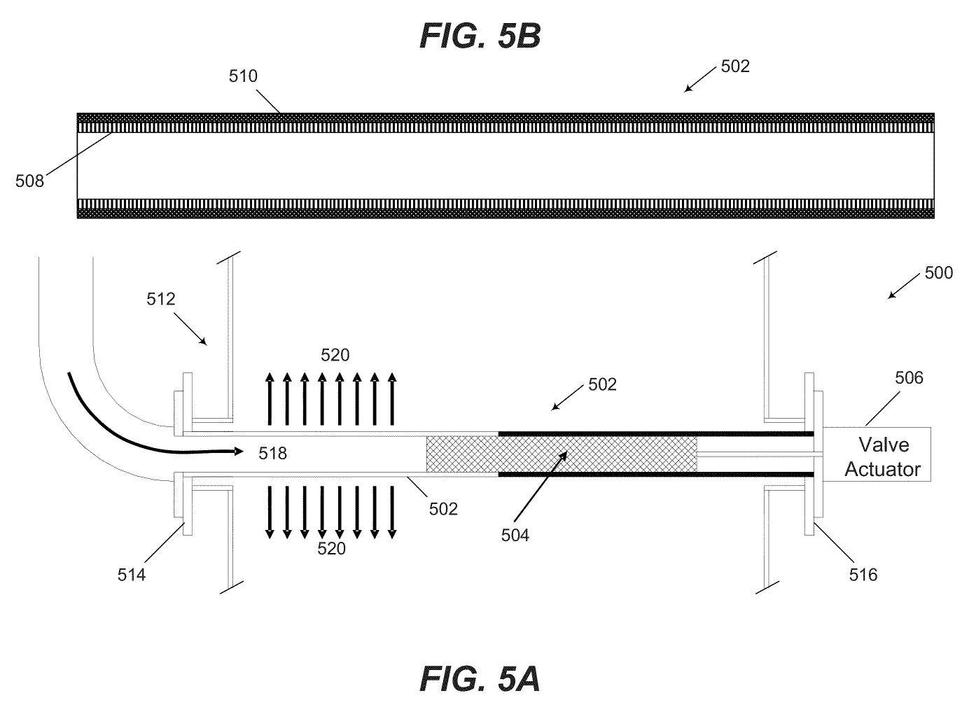

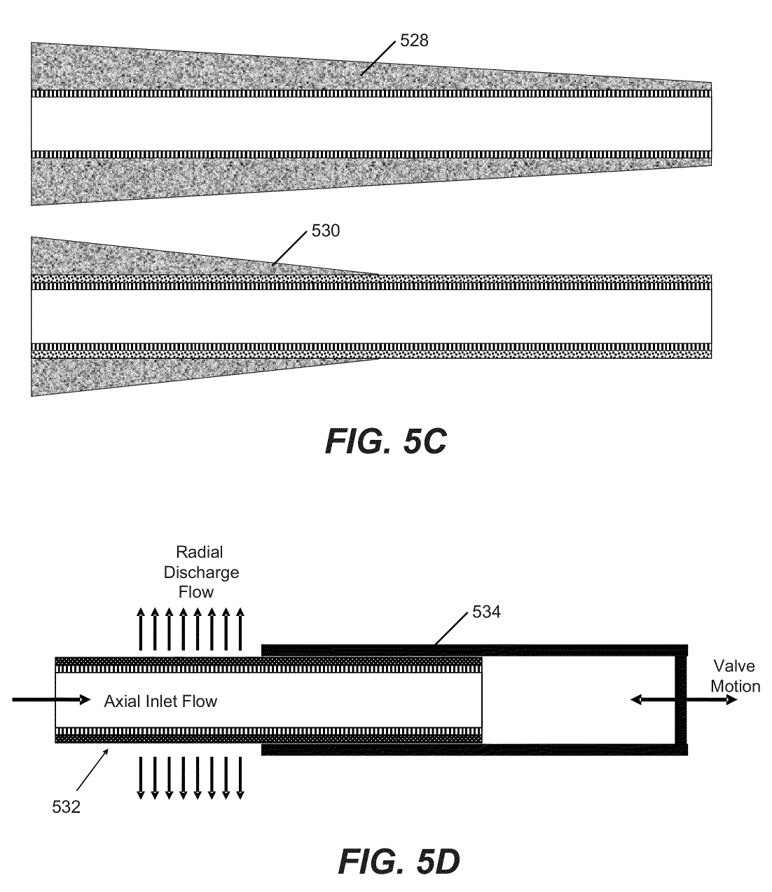

FIG. 4 illustrates a schematic view of an example valve and pressure drop profile in accordance with an embodiment of the invention, and FIGS. 5A-5D illustrate schematic views of another example valve in accordance with an embodiment of the invention. The valve designs shown in FIGS. 4 and 5A-5D may be in-tank, piston-in-sleeve arrangements. The valves 400, 500 in FIGS. 4 and 5A-5D can include a porous sleeve assembly 402, 502, a flow control piston 404, 504, and an actuator 406, 506, and can operate in a similar manner to the embodiments shown in FIGS. 2 and 3. The valve pressure and velocity profiles in FIG. 4 illustrate the elimination of the high internal valve velocity and associated local pressure minimum found in certain prior art valves as illustrated in FIG. 1. The region of pressure in the prior art valve of FIG. 1, which falls below the valve discharge pressure (P2) and the associated high velocity, have been eliminated in the embodiment of the invention illustrated in FIG. 1. This is possible, at least in part, because the invention employs the porous restrictor element 402 to render pressure drop in the valve by viscous dissipation rather than accelerating the fluid to high velocity and generating pressure drop through turbulent dissipation, as in the prior art.

In the embodiments shown in FIGS. 5A-5D, the porous sleeve assembly 502 can be a cylindrically-shaped device and can include a guard 508 (e.g., the inner tube) made from a perforated metal and a restrictor 510 (e.g., the outer tube) made from a sintered porous media. For example, the restrictor 510 can be approximately 36 inches (0.92 m) in length, and about 3.5 inches (8.89 cm) with a wall thickness of about 0.2 inch (5.1 mm). The sintered porous media can have pores of approximately 20 microns (0.020 mm) in diameter. Similar to the flow restrictor portion 302 described in FIG. 3, the restrictor 510 of the porous sleeve assembly 502 can include at least one of a porous media or a layered or stacked wire mesh or screen. Materials suitable for the restrictor portion include metal, plastic or ceramic, such as stainless steel, brass, bronze, a porous metal, a porous plastic, or a porous ceramic. If desired, to tailor the pressure drop characteristic as a function of valve position, the restrictor may have a wall thickness that varies in a linear or nonlinear fashion along its length, as illustrated by restrictors 530 and 528 in the embodiments of FIG. 5C.

The guard 508 of FIGS. 5A-5D can be a relatively thick wall perforated tube wrapped by the restrictor 510 and comprising a porous medium such as a sintered metal or screen. Preferably, the perforations of the guard 508 are materially larger than the passages in the porous restrictor 510 so the inner tube imposes little to no restriction on the flow, that is, unless such restriction is desired. By way of example only, the guard 508 can be a perforated metal tube approximately 36 inches (0.92 m) in length, about 3.0 inches (7.62 cm) ID with a wall thickness of about 0.25 inch (6.35 cm), and approximately 50% open area. If flow restriction is desired in the guard 508, then the thickness of the guard tube wall and/or the size of its openings may be sized to provide the desired flow restriction.

In an embodiment shown in FIG. 5D, the restrictor and guard of a porous sleeve assembly 532 may be disposed inside the throttle, which itself may take the form of a tube 534. In this embodiment, the throttle forms the outer tube surrounding the restrictor by the guard, wherein the guard is disposed between the throttle and the restrictor.

In any instance, in the embodiment shown in FIGS. 5A-5D, a combination of the guard and restrictor can facilitate a relatively tight radial clearance between the flow control piston throttle tube and the guard of the porous sleeve assembly 502 to control leakage flow while minimizing or otherwise preventing contact between the surface of the flow control piston and the porous media of the restrictor, which could result in closing some or all of the media pores and rendering the valve inoperable.

The porous medium of the restrictor may impose a flow-controlling pressure drop as illustrated, for example, by the pressure and velocity graphs 408 of FIG. 4, by providing predominantly viscous dissipation or a similar mechanism, which can minimize or otherwise eliminate relatively high fluid velocities responsible for the problems experienced in conventional control valves. The porous medium of the restrictor may also result in a low Reynolds number flow reducing, if not substantially eliminating, turbulent dissipation. The wrapped tube design can also facilitate flexibility in tailoring certain valve characteristics, such as pressure drop and flow capacity as a function of valve position, for a wide variety of applications.

One will recognize the ability to spatially vary the permeability of the porous sleeve assembly through simple modifications to its guard and/or restrictor components to tailor or otherwise define certain valve characteristics, such as pressure drop and flow capacity as a function of valve position, in accordance with embodiments of the invention. For example, the pore size of the sintered media used to form the restrictor and/or the radial thickness of the restrictor 510 may be varied along its length in a linear or nonlinear fashion, as illustrated in FIG. 5C.

With reference to FIG. 5A, the porous sleeve assembly 502 can be mounted inside a reservoir tank 512 between two tank wall flanges 514, 516. Fluid can axially 518 (e.g., axial inlet flow) enter the porous sleeve assembly 502 of the valve 500 and can flow radially outward 520 (e.g., radial discharge flow) through the porous media of the restrictor of the porous sleeve assembly 502 into the reservoir tank 512. The flow rate of the valve 500 can be controlled by varying the available flow area through the porous media of the restrictor by varying the position of the flow control piston 504. The flow control piston 504 can be a sliding piston, which can slide or otherwise move with respect to and internal to the porous sleeve assembly 502.

Similar to the throttle portion 304 described in FIG. 3, the flow control piston 504 can include at least one of the following: a translating piston, a sliding plate, a rotating cylinder, a rotating plate, a pivoting wall, or a mechanism which changes the flow area.

Other system and valve embodiments in accordance with the invention can include fewer or greater numbers of components and may incorporate some or all of the functionalities described with respect to the system and valve components shown in FIGS. 4 and 5A-5D.

It will be appreciated that while the disclosure may in certain instances describe a valve or system with only a single flow restrictor portion, throttle portion, guard portion, and seal portion, there may be multiple flow restrictor portions, throttle portions, guard portions, and seal portions in certain system or valve embodiments without departing from example embodiments of the invention.

In certain embodiments, a microprocessor and/or computer can be in communication with any of the components of the systems and valves described with respect to FIGS. 2-4, and 5A-5D. The microprocessor and/or computer can execute computer-executable program instructions stored in a computer-readable medium or memory, such as a random access memory (“RAM”), read-only memory (“ROM”), and/or a removable storage device, coupled to the processor 216 in FIG. 2. In one embodiment, a microprocessor and/or computer may include computer-executable program instructions stored in the memory or the microprocessor for monitoring and controlling one or more valve characteristics, such as pressure drop and flow capacity, of a valve, such as 202, 300, 400, 500 or a system, such as 200. For example, a microprocessor such as 216 and/or a computer can be in communication with one or more sensors oriented at an inlet and outlet of a valve, such as 202 in FIG. 2. The microprocessor can include one or more instructions stored in memory 218, and operable to control the valve 202 in response to one or more flow characteristics of the valve 202 or external commands provided by a user. In response to inlet flow and outlet flow characteristics of the valve 202, the microprocessor 216 and/or the computer can manipulate certain components of the valve, such as a valve actuator and/or a flow control piston with respect to a porous sleeve assembly, to control one or more flow characteristics of the valve 202. Other system and valve embodiments operating in conjunction with a microprocessor and/or computer can be implemented in accordance with embodiments of the invention.

One skilled in the art may recognize the applicability of embodiments of the invention to other environments, contexts, and applications. One will appreciate that components of the system 200 and valves shown in and described with respect to FIGS. 2-4 and 5A-5D are provided by way of example only. Numerous other operating environments, system architectures, and apparatus configurations are possible. Accordingly, embodiments of the invention should not be construed as being limited to any particular operating environment, system architecture, or apparatus configuration.

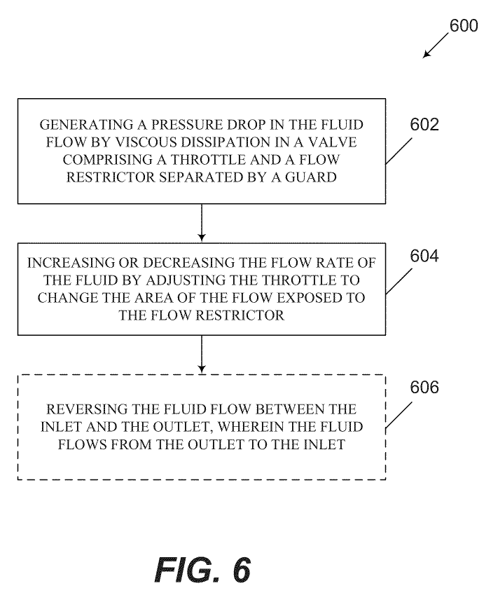

Embodiments of a system, such as 200, can facilitate providing a flow control valve. Improvements in providing a flow control valve, can be achieved by way of implementation of various embodiments of the system 200, the valves described in FIGS. 2-4, and 5A-5D and the methods described herein. Example methods and processes which can be implemented with the example system 200 and/or the valves described in FIGS. 2-4, and 5A-5D are described by reference to FIG. 6.

FIG. 6 illustrates an example method for controlling fluid flow between an inlet and an outlet. The method 600 begins at block 602, in which a pressure drop is generated in the fluid flow by viscous dissipation, that is, predominantly viscous dissipation because there may be some turbulent dissipation in any valve. This is done with a valve comprising a throttle and a flow restrictor separated by a guard in accordance with embodiments of the present invention.

In one aspect of one embodiment, generating a pressure drop in the fluid flow by viscous dissipation can include a fluid flowing through a portion of a porous tube.

Block 602 is followed by block 604, in which the flow rate of the fluid between the inlet and the outlet is increased or decreased by adjusting the throttle to change the area of fluid flow exposed to the restrictor.

In one aspect of one embodiment, increasing or decreasing the flow rate of the fluid between the inlet and the outlet can include manipulating at least one of the following: a translating piston, a sliding plate, a rotating cylinder, a rotating plate, a pivoting wall, or a mechanism which changes the flow area. For example, increasing or decreasing the flow rate of the fluid between the inlet and the outlet can include manipulating a piston to change the area of the restrictor available for fluid flow.

The movement of the throttle is facilitated by the guard, which separates the throttle from the porous media restrictor. The guard protects the restrictor and provides a tight fit with the throttle to decrease leakage and prevent wear and/or damage to the restrictor.

Block 604 is followed by optional block 606, in which the fluid flow between the inlet and the outlet is reversed, wherein the fluid flows from the outlet to the inlet, which is an optional step.

After optional block 606, the method 600 can end.

Embodiments of the invention are described above with reference to block diagrams and flow diagrams of systems, methods, apparatuses, and computer program products. It will be understood that some or all of the blocks of the block diagrams and flow diagrams, and combinations of blocks in the block diagrams and flow diagrams, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flow diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams may support combinations of means for performing the specified functions, combinations of elements for performing the specified functions, and program instruction means for performing the specified functions. It will also be understood that some or all of the blocks of the block diagrams and flow diagrams, and combinations of blocks in the block diagrams and flow diagrams, can be implemented by special purpose hardware-based computer systems that perform the specified functions, elements, or combinations of special purpose hardware and computer instructions.

Additionally, it is to be recognized that, while the invention has been described above in terms of one or more embodiments, it is not limited thereto. Various features and aspects of the above described invention may be used individually or jointly. Although the invention has been described in the context of its implementation in a particular environment and for particular purposes, its usefulness is not limited thereto, and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

The claimed invention is:

1. A valve comprising:
a flow restrictor portion operable to generate a pressure drop in a fluid flow by viscous dissipation;
a throttle portion operable to change a flow rate of the fluid; and
a guard portion operable to separate the flow restrictor portion from the throttle portion.

2. The valve of claim 1, further comprising:
a seal portion operable to decrease leakage between the throttle portion and the guard portion.

3. The valve of claim 1, wherein the flow restrictor portion comprises a porous sleeve, the guard portion comprises a perforated tube within the porous sleeve, and the throttle portion comprises a piston within the perforated tube.

4. The valve of claim 1, wherein the flow restrictor portion comprises a plurality of randomly distributed passages.

5. The valve of claim 4, wherein the flow restrictor portion comprises at least one of the following: a porous media, a wire mesh, or a screen.

6. The valve of claim 4, wherein the porous media comprises at least one of stainless steel, brass, bronze, a sintered porous metal, a porous plastic, or a porous ceramic.

7. The valve of claim 1, wherein the throttle portion comprises at least one of the following: a translating piston, a sliding plate, a rotating cylinder, a rotating plate, a pivoting wall, or any mechanism which changes the area of the restrictor exposed to the fluid flow.

8. A method for controlling fluid flow between an inlet and an outlet, the method comprising:
generating a pressure drop in the fluid flow by viscous dissipation across a flow restrictor; and
increasing or decreasing the flow rate of the fluid across a restrictor by modifying the position of a throttle relative to the restrictor, wherein the throttle and restrictor are separated by a guard.

9. The method of claim 8, wherein the restrictor comprises a plurality of randomly distributed passages.

10. The method of claim 8, wherein the guard comprises a perforated tube.

11. The method of claim 8, wherein the restrictor comprises a porous sleeve, and wherein the fluid flows through one or more pores in the sleeve.

12. The method of claim 8, wherein the restrictor comprises a porous media, and wherein the fluid flows through the porous media.

13. The method of claim 12, wherein the pressure drop across the porous media is produced by laminar flow through viscous dissipation.

14. The method of claim 8, wherein increasing or decreasing the flow rate of the fluid through a restrictor comprises manipulating the throttle position to change the restrictor surface area exposed to the flow.

15. The method of claim 8, wherein increasing or decreasing the flow rate of the fluid through a restrictor comprises manipulating at least one of a translating piston, a sliding plate, a rotating cylinder, a rotating plate, a pivoting wall, or a mechanism which changes the flow area.

16. A system for controlling fluid flow, the system comprising:
at least one of a storage tank, a pipe, a hose, or a pump; and
a valve, comprising:
a flow restrictor portion comprising a porous media that provides laminar pressure drop through viscous dissipation;
a throttle portion operable to change a flow rate of the fluid through the flow restrictor portion; and
a guard portion operable to separate the flow restrictor portion from the throttle portion.

17. The system of claim 16, wherein the flow restrictor portion comprises a plurality of substantially randomly oriented passages in series and/or parallel.

18. The system of claim 16, wherein the porous media comprises a plurality of randomly distributed passages that produce laminar flow through the valve by viscous dissipation.

19. The system of claim 18, wherein the porous media comprises at least one of stainless steel, brass, bronze, a sintered porous metal, a porous plastic, or a porous ceramic.

20. The system of claim 16, wherein the throttle portion comprises at least one of the following: a translating piston, a sliding plate, a rotating cylinder, a rotating plate, a pivoting wall, or a mechanism which changes the flow area.
